(19) United States
(12) Patent Application Publication
(10) Pub. No.: US 2008/0185266 A1
(43) Pub. Date: Aug. 7, 2008

(54) Conveying Device, Conveying Process and Logistics System

(75) Inventors: Thomas Sturm, Wiedenzhausen (DE); Konrad Liepert, Merching (DE); Jurgen Pfeifer, Meitingen-Erlingen (DE)

Correspondence Address: MCGLEW & TUTTLE, PC, P.O. BOX 9227, SCARBOROUGH STATION, SCARBOROUGH, NY, 10510-9227, US

(73) Assignee: KUKA SCHWEISSANLAGEN GMBH, AUGSBURG (DE)

(21) Appl. No.: 11/911,384

(22) PCT Filed: Mar. 31, 2006
(86) PCT No.: PCT/EP06/02924

§ 371 Date: Oct. 12, 2007

(30) Foreign Application Priority Data
Apr. 14, 2005 (DE) 20 2005 006 042.9
Dec. 24, 2005 (DE) 20 2005 020 225.8

(51) Int. Cl. B65G 35/08

(52) U.S. Cl. 198/465.2

(57) ABSTRACT

A transport device and a method for transporting motor vehicle body parts (4) is provided. The transport device (49) includes a transportable frame (51) with at least one preferably bar-shaped supporting device (55) for receiving the parts (4) in a stack (5). The transport device (49) includes a loading device (56) which allows individual parts (4) to be put on the supporting device (55) at a loading position (47) and allows delivery of the stack (5) of parts to an unloading position (48) where the stack (5) of parts is pushed off the supporting device (55).

### CROSS REFERENCE TO RELATED APPLICATIONS

This application is a United States National Phase application of International Application PCT/EP2006/002924 and claims the benefit of priority under 35 U.S.C. §119 of each or German Patent Application DE 20 2005 006 042.9 filed Apr. 14, 2005 and German Patent Application DE 20 2005 020 225.8, filed Dec. 24, 2005 the entire contents of which are incorporated herein by reference.

### FIELD OF THE INVENTION

The pertains to a transport or conveying device and to a conveying process for mechanical components, especially body parts or other vehicle parts, with conveying means having a portable frame for receiving at least one stack of components.

### BACKGROUND OF THE INVENTION

Conveying means for body parts are known from practice, which have a portable frame in the form of a multiple-support rack, into which the components are inserted one by one and removed one by one. The components are held one by one in the rack and spaced with spacers. Furthermore, it is known from practice that components can be inserted one by one into a frame while forming a stack of components and can be removed from the frame one by one. The loading and unloading take place on the same side. The components are usually spaced apart from one another and held one by one in the frame usually by means of spacers.

The prior-art logistics are labor-intensive, require much manpower and are time-consuming. The components are frequently transferred between the prefabrication unit, e.g., a press department, and the next machining station. In addition, the feeding of components into machining stations that are critical for safety and are surrounded by a protective fence is problematic. When the prior-art racks or stacking frames are brought into such a machining station, the safety regulations require that the machining station and its components be stopped from time to time, which leads to an undesired work interruption and requires stocking of a larger amount of components, which leads to a corresponding space requirement within the machining station. If components are fed to the machining station from the outside, this is carried out manually with the use of rotary tables or the like, the worker inserting the components one by one in the machining cycle. This requires a considerable amount of manpower. On the whole, the prior-art component logistics are associated with loss of efficiency and economic disadvantages.

### SUMMARY OF THE INVENTION

The object of the present invention is to show better conveying and logistic possibilities.

According to one aspect of the invention a conveying device is provided for conveying mechanical components, body part components or other vehicle part components. The conveying device comprises a portable frame for receiving at least one the stack components, a bar-shaped carrying means associated with the frame for receiving the components in the stack and a loading means for attaching individual components to the carrying means at a loading site and to release the stack of components at an unloading site.

The conveying technique being claimed has the advantage that the efficiency and the economy of the component logistics can be markedly improved. Manual activities and ergonomic problems associated with them can be reduced in the entire logistics area. An optimized logistics solution going beyond the entire production process can be offered with the conveying means being claimed. The conveying means as well as the logistics that can be equipped with it can be integrated in new plants, and it is also possible to adapt and correspondingly optimize the production processes. Furthermore, retrofitting or changeover for existing production plants is also possible. The effort needed for adaptation is small compared to the improvements that can be accomplished.

Other advantages lie in the possibility of using basic constructions with little effort for components of greatly different types and sizes. In addition, the conveying technique and logistics being claimed offer simple and efficient security against inserting the components incorrectly. Sources of error are reduced due to the fact that manual activities are extensively eliminated. The reliability of operation and accident-proofness are increased in the entire conveying and logistics chain. In addition, the safety measures to be taken on the different parts of the production plant can be reduced by standardized interfaces.

Furthermore, it is possible to feed components more rapidly when needed due to the conveying means being claimed with defined mounts. On the whole, the degree of automation can be increased in the conveying technique and logistics.

The frame and/or the components can be provided with a code, by means of which the flow of materials can be monitored and controlled in an optimized manner via the connection to corresponding writing and/or reading means. Due to the conveying technique and logistics according to the present invention, it is sufficient to monitor the stack of components on the conveying path. Individual detection of the components can be reduced to the loading site and unloading site. The monitoring of the flow of materials offers the manufacturers involved in the production process the possibility of completely detecting and documenting the assignment of the components from their manufacture to the end product of the finished vehicle. Errors that will appear only later in the manufacturing process of the vehicle can be traced back by means of the assignment to the site and point in time at which they occurred, which also creates possibilities of a corresponding purposeful remedy. Moreover, quality is improved in the entire manufacturing process due to the complete component monitoring. In addition, advantages arise concerning the proof of quality and product liability.

The present invention is schematically shown as examples in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing an embodiment of a variant of a logistics system with a conveying means;

FIG. 2 is a schematic view showing an embodiment of another variant of a logistics system with a conveying means;

FIG. 3 is a side view of a conveying means with a frame and a carrying means;

FIG. 4 is a tilted front view of the conveying means with a frame and a carrying means;

FIG. 5 is a detail view of a loading site of the conveying means at a prefabrication unit;

FIG. 6 is a detail view of a feeding means at a machining station in one of various operating steps and in a tilted view;

FIG. 7 is a detail view of a feeding means at the machining station in another of various operating steps and in a tilted view;

FIG. 8 is a detail view of a feeding means at the machining station in another of various operating steps and in a tilted view;

FIG. 9 is a detail view of a feeding means at the machining station in another of various operating steps and in a tilted view;

FIG. 10 is a detail view of a feeding means at the machining station in another of various operating steps and in a tilted view;

FIG. 11 is a detail view of a conveying means at an unloading site at a feeding means with a stack transfer in one of different operating steps;

FIG. 12 is a detail view of a conveying means at the unloading site at the feeding means with a stack transfer in another of different operating steps;

FIG. 13 is a detail view of a conveying means at the unloading site at the feeding means with a stack transfer in another of different operating steps;

FIG. 14 is a detail view of a conveying means at the unloading site at the feeding means with a stack transfer in another of different operating steps;

FIG. 15 is an enlarged view of detail XV from FIG. 11 with a docking means;

FIG. 16 is a view showing a variant of the conveying means at the unloading site at a feeding means with transfer from the carrier and the stack of components in one of different operating steps;

FIG. 17 is a view showing a variant of the conveying means at the unloading site at a feeding means with transfer from the carrier and the stack of components in another of different operating steps; and

FIG. 18 is a view showing a variant of the conveying means at the unloading site at a feeding means with transfer from the carrier and the stack of components in another of different operating steps.

### DESCRIPTION OF THE PREFERRED EMBODIMENTS

Referring to the drawings in particular, The present invention pertains to a conveying means (49) and a conveying process for mechanical components (4), especially body parts or other vehicle parts, and a logistics system (42) with at least one such conveying means (49).

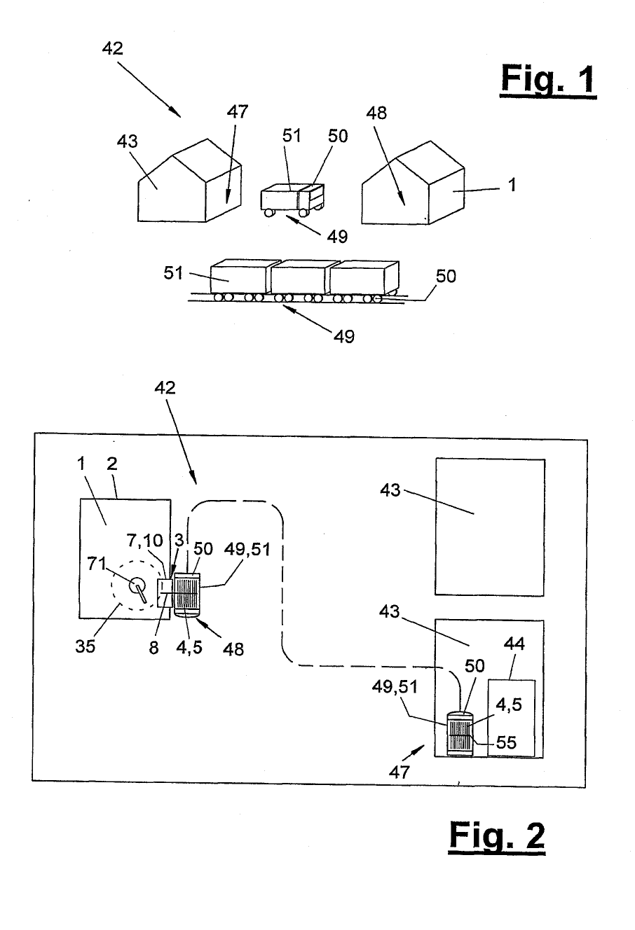

FIGS. 1 and 2 show two different variants of the logistics system (42). The logistics system (42) comprises a production plant for the manufacturing and the further machining of the components (4), which contains, e.g., the prefabrication unit (43) shown schematically and a machining station (1), e.g., a shell manufacturing unit for vehicles. The logistics system (42) comprises, furthermore, the above-mentioned conveying means (49), which conveys the components (4) in a stack of components (5) from the prefabrication unit (43) to the machining station (1) and transfers them there to the feeding means (7). The loading and stacking are carried out at a loading site (47) in or in the area of the prefabrication unit (43). The stack of components (5) is released at an unloading site (48) at the machining station (1) and a feeding means (7) located there.

The conveying means (49) comprises at least one portable frame (51) for receiving the components (4) and at least one stack of components (5). In the variant according to FIG. 1, the prefabrication unit (43) and the machining station (1) are at a great distance from each other in space, and the frames (51) are conveyed over the distance with a conveying means (50), e.g., with a vehicle, especially with a rail-borne or road vehicle or the like. The conveying means (50) can also be loaded with one or more frames (51) at the loading site (47) or at another suitable location. The unloading of the frame or frames (51) can likewise be carried out directly by the conveying means (50) at the unloading site (48) or at another suitable location in the more immediate surroundings of the machining station (1).

In the variant according to FIG. 2, the prefabrication unit (43) and the machining station (1) are located close to each other and are accommodated, e.g., at a common production site or in one hall. The frames (51) can be conveyed in this case with an internal conveying means (50) of the plant, e.g., a remote-controlled conveying vehicle, especially an inductively guided FTS (driverless conveying system), a manually operated forklift or the like. In another variant, the frames (51) may be designed as self-propelled frames with remote control or with operator control, so that the frame loading and unloading operations onto a conveying means (50) are eliminated.

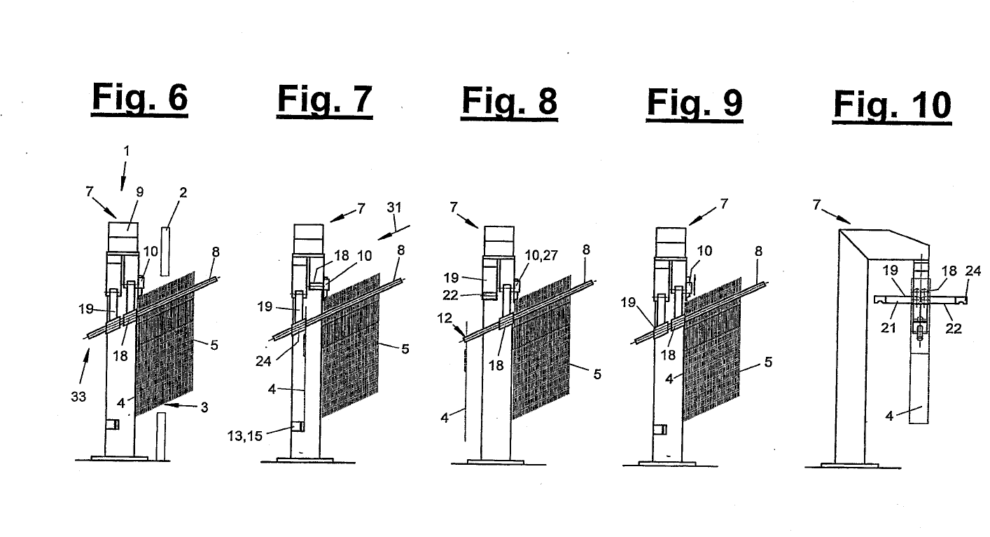

FIG. 2 schematically shows the design of a machining station (1). It is surrounded on the outside by a safety means (2), e.g., a protective fence. A plurality of automatic machining devices, e.g., the robot (71) shown schematically, are arranged inside the station. The components (4) and the stack (5) of components are fed through an opening (3) in the safety means (2) or in the protective fence by means of the feeding means (7) arranged in this area. The operation of the station does not need to be interrupted during this feed. The feeding means (7) has a separating device (10), with which the components (4) in the stack (5) of components can be separated and made available for receiving and further machining on a release side (33) in the work area (35) of the robot (71). The loading side (32) of the feeding means (7) is in or outside the opening (3). The separation operations in the feeding means (7) are shown in operating steps in FIGS. 6 through 9. FIG. 10 shows a tilted side view.

The components (4) may be of any desired type and size. They preferably have at least one passage opening (6), which is closed on the circumferential side. By means of this passage opening (6), they can be attached to a carrying means (55) at the frame (51) or to a carrier (8) at the feeding means (7) one by one or in a stack (5) and are held there preferably suspended or optionally additionally upright. The carrier (8) and the carrying means (55) are preferably of the same design. They have, for example, a bar shape and may consist of one or more carrying bars. The carrying bars pass through the passage openings (6), of which there may be one or more than one. As an alternative or in addition, the carrying bars may also act as support bars, which act on the components (4) on the outside.

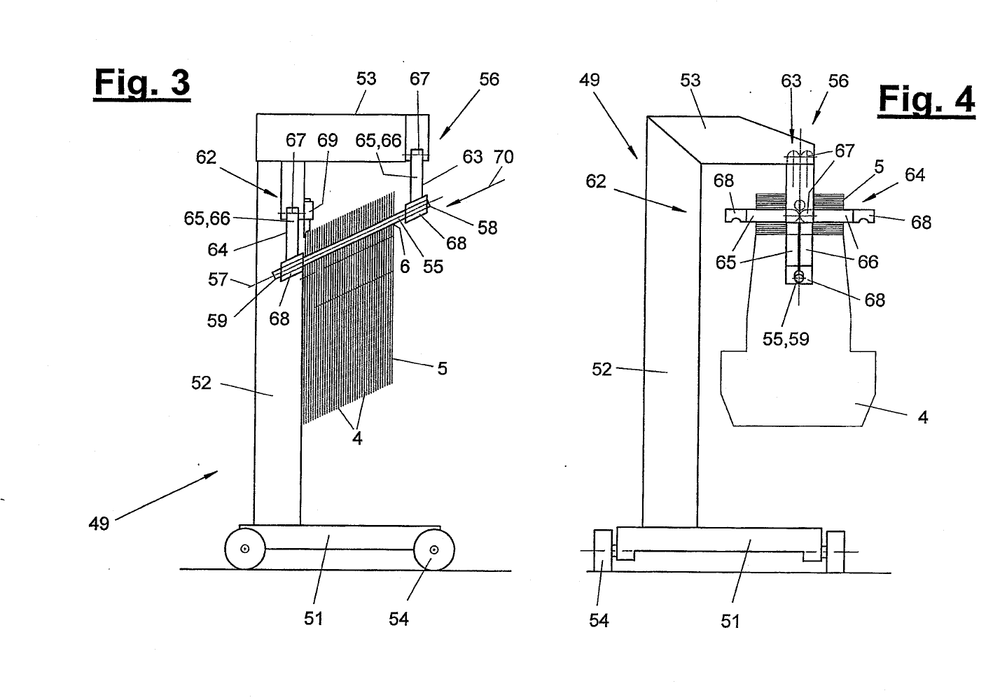

FIGS. 3 and 4 show a frame (51) in an exemplary embodiment, FIG. 3 showing the side view and FIG. 4 the front view tilted by 90°. The frame (51) may be portable in any desired manner. In the exemplary embodiment being shown, it has a running gear (54) of its own with a plurality of rollers. It may be pushed and maneuvered by a worker manually. In addition, a drive with corresponding energy supply and a manual or remote-controllable control (neither one being shown) are, in addition, present in case of the self-propelled variant. In a variant of the embodiment being shown, the running gear (54) may be eliminated. Furthermore, it is possible to provide sliding rails or the like instead of a running gear. In another variant, the frame (51) may have mounts for the prongs of a forklift or another conveying means.

In one variant, not shown, the frame (51) may be accommodated in a container or another conveying container, which has, e.g., the standard dimensions usual in logistics and has usually one wall with a door or flap that can be opened. Such a container is suitable for road, sea and/or air transportation over longer distances. Functionally correct access to one or more frames (51) accommodated in the container is guaranteed with a suitable closable opening, which is formed, e.g., by a rolling wall. With such a design, the container can be loaded directly at a loading site (47) and directly unloaded at the unloading site (48) at the machining station (1). Furthermore, it is possible to arrange the container on a vehicle (50), e.g., on a truck or a freight car. In another variant for use within the plant, the frame (51) may be surrounded for conveying by a suitable protective cover, e.g., a curtain, a folding wall or the like.

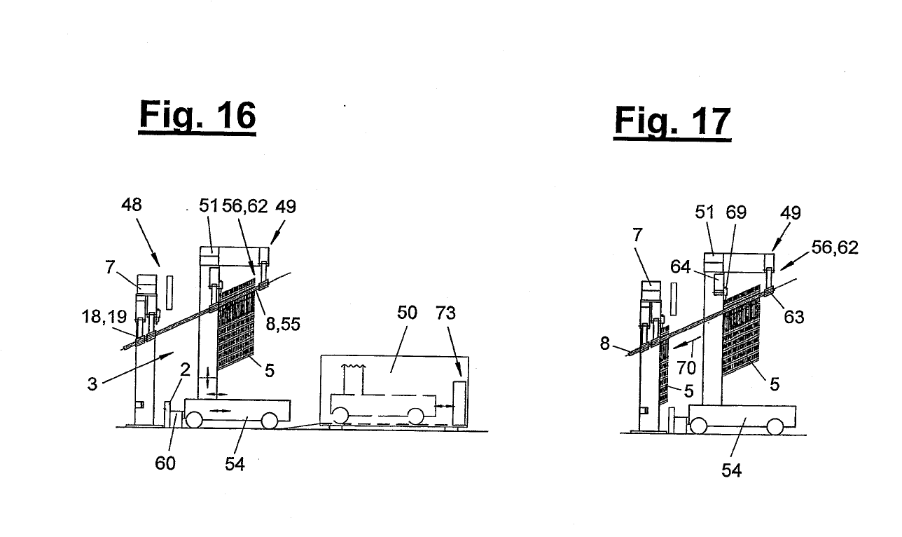

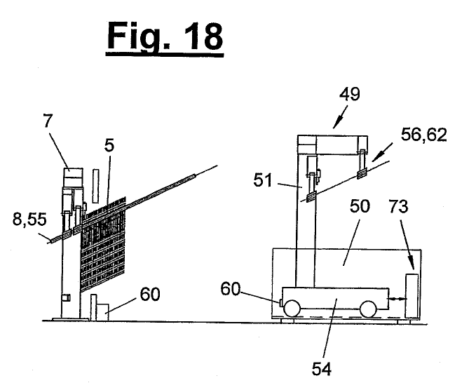

In the variant of the arrangement of the frame (51) on a remote-controllable conveying vehicle (50), e.g., on an inductively guided driverless conveying system, which is indicated in FIGS. 2 and 16 through 18, the frame (51) may remain on the vehicle (50) or loaded or unloaded at the loading and unloading sites (47, 48) as needed. The driverless conveying system (50) may have for this purpose, e.g., a conveying platform for receiving one or more frames (51) and possess a loading device, with which loading device the frame or frames (51) are loaded and unloaded and slide in the process on rails or the like or roll with the running gear (54). FIGS. 16 and 18 schematically show such a conveying means (50) with a loading means (73) for loading and unloading the frames (51).

The frame (51) is designed, e.g., as a rigid or mobile supporting frame for one or more carrying means (55). In the embodiment being shown, it has a bottom part with at least one, preferably upright or vertical column (52) and with at least one arm (53), which projects laterally away from the support (52). The frame (51) may be designed as a mobile frame per se as a height-adjustable frame with suitable setting means that can be actuated manually or mechanically or in another manner.

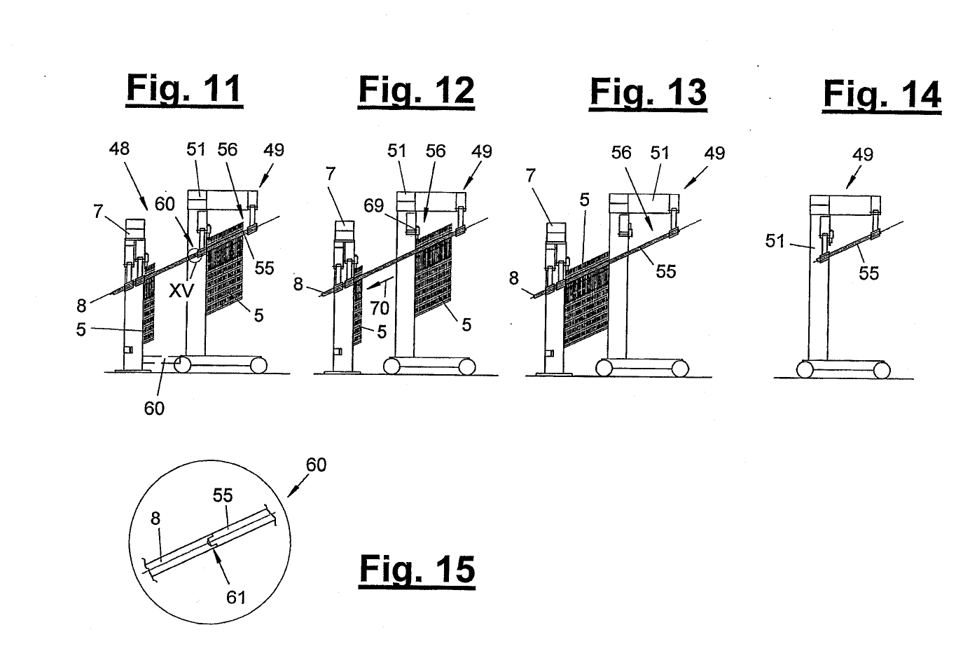

A loading means (56) of any suitable design is arranged at the frame (51). This [loading means] makes it possible to attach individual components (4) or components (4) fed in groups to the carrying means (55) at a loading site (47), and a stack (5) of components is formed on the carrying means (55). Furthermore, the loading means (56) makes it possible to release the stack (5) of components at least one unloading site (48). There are various variants for this. On the one hand, the stack of components can be pushed off from the carrying means (55) in the embodiment being shown and pushed over in the process preferably onto the carrier (8) of the feeding means (7). FIGS. 11 through 14 show this operation. In the other variant, shown in FIGS. 16 through 18, the stack (5) of components can be released together with the carrying means (55) and transferred, e.g., to the feeding means (7). Parts of the stack (5) of components can be released in another variant.

As is shown in FIGS. 3 through 4, the loading means (56) has a mobile bracket (62), with which the carrying means (55) is held detachably and at least at times airborne. The bar-shaped carrying means (55) is held airborne at one of its ends (59), which is the release-side end, while the other, feed-side end (58) is released, so that components (4) can be attached here with their passage opening (6). After the end of loading, the bracket (62) again grasps the carrying means (55) at both ends (58, 59) and secures the stack (5) of components as a result and ensures reliable mounting of the carrying means (55).

The bracket (62) holds the carrying means (55) preferably horizontally or obliquely and holds it at such a height that the components (4) can be picked up suspended. The feed-side end (58) is located higher than the release-side end (59). Due to this oblique setting, the components (5) fed slide downwards along the preferably straight carrying bar (55) in the direction of arrow (70) under their own weight. A conveying means supporting the feed (not shown) may optionally be additionally present. The downward path is limited by a controllable retainer (69), which is arranged at the feed-side lower end (58) in the direction of arrow (70) in front of the bracket (62) and fixes the first component (4) with a retaining finger from the top or from a suitable location. The components (4) following it slide onto the respective component located in front and form the stack (5) of components. The components (4) mutually touch each other in the stack (5) in the embodiment being shown. The components (4) may mesh with one another and nest together with projections and opposite recesses which may optionally be present in a positive-locking manner. Stop faces provided specifically for this purpose may also be present now on the components (4). In the preferred embodiment being shown, the components (4) are designed as essentially flat sheet metal parts, in which the projections and recesses are formed by embossing or during deep-drawing. Due to these designs and the nesting together, the components (4) in the stack (5) mutually guide and stabilize themselves. In addition, mutual incorrect positions of the components (4) due to the formation of different distances are immediately recognized. If twisting of a component takes place due to an operating error, this likewise becomes optically noticeable in terms of amount in the stack (5) of components.

As is shown by FIGS. 11 through 14, which will be specifically explained below, the oblique positions of the carrying means (55) and of the carrier (8) at the feeding means (7) are mutually adapted. The slope angle against the horizontal is, e.g., approx. 20° and is optionally adjustable. The axes (57) are preferably aligned. The carrier (8) and the carrying bar (55) together form a stepless, continuous sliding bar, along which the components (4) can slide.

The bracket (62) has at least two spaced-apart gripping means (63, 64), which can be actuated one by one, for detachably holding the carrying means (55). The gripping means (63, 64) preferably hold one end (58, 59) each of the carrying bar (55). To load the carrying means (55), the upper gripping means (63) is opened and released, so that the components (4) can be attached to the free upper bar end (58). The lower gripping means (64) is closed during this time. The upper gripping means (63) also closes again after loading, so that the stack (5) of components and the carrying means (55) are held firmly and reliably on both sides during conveying. The lower gripping means (64) is opened during the transfer of the stack at the unloading site (48), so that the stack (5) of components can slide off and can be released after the subsequent actuation of the retainer (69).

The two gripping means (63, 64) are arranged suspended, e.g., at the arm (53) and may have any desired and suitable design. In the embodiment being shown, each gripping means (63, 64) has two parallel supporting arms (65, 66), which have a drag bearing (67) each at their upper ends and an, e.g., shell-shaped gripping element (68) at their lower end. To open the gripping means (63, 64), the supporting arms (65, 66) are pivoted apart from each other and folded up, as this is shown in the front view in FIG. 4. In the pivoted-down position, the half shell-shaped mounts of the gripping elements (68) form with one another the aforementioned shell-shaped mount, which may have an oblique orientation corresponding to the slope of the bar and extends, e.g., around the carrying means (55) comprising an individual bar on the circumferential side. In variation of this, it is possible to form the carrying means (55) and the carrier (8) from a plurality of parallel bars, which are grasped and optionally clamped on one side by the gripping means (18, 19, 63, 64) with correspondingly spaced supporting arms and with half-shell-shaped gripping elements.

Furthermore, the gripping means (63, 64) may be designed and arranged as upright or laterally projecting gripping means. Furthermore, the gripping elements (68) may have any other desired shape and function. For example, the gripping means (63, 64) may be designed as threaded bars, which are turned into and out of corresponding threaded holes on the carrying means (55).

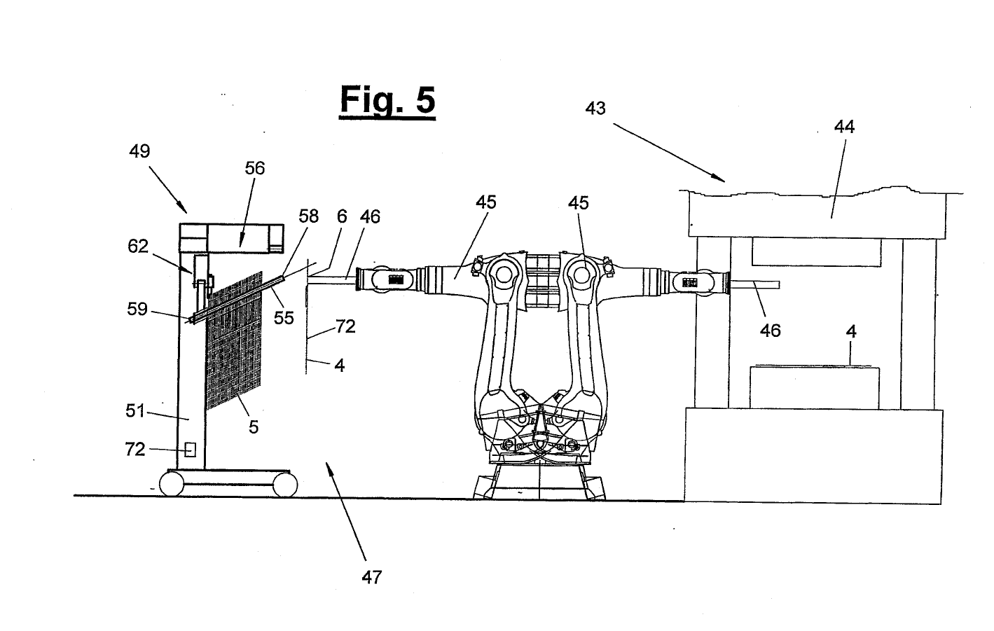

FIG. 5 shows a frame (51) in a loading site (47) in the immediate vicinity of a press (44). The finished pressed sheet metal component (4) is removed from the press (44) with a tool (46) fastened to the robot hand with any desired and suitable unloading device (45), e.g., a usual press feeder or the articulated arm robot shown in two operating positions in FIG. 5, fed to the opposite frame (51) with a pivoting motion and attached to the carrying means (55) there. After releasing the tool (46), the component (4) slides downward onto the oblique stack (5) of components or onto the retainer (69). The empty robot (45) pivots back and picks up the next sheet metal component (4), which has meanwhile been finished, and feeds it to the frame (51). Depending on the cycle time, a plurality of presses (44) can be unloaded by one or more unloading devices (45), and the sheet metal components (4) are attached to a common frame (51) or to different frames (51). A plurality of carrying means (55), which are loaded from a plurality of presses (44), may also be arranged next to each other at one frame (51).

FIGS. 6 through 10 illustrate the feeding means (7) illustrated in the introduction, which may be present as one feeding means or as a plurality of feeding means at the edge of the machining station (1). The feeding means (7) has a support means (9) for the bar-shaped carrier (8) mentioned, which support means may be designed as a bracket similarly to the above-mentioned frame (51). Two, likewise individually controllable gripping means (18, 19), which may be designed similarly as in the case of the frame (51) and may have two supporting arms (21, 22) each and one or more gripping elements (24), are likewise provided here for the carrier (8). The distance between the gripping means (18, 19) is smaller in this case than in the case of the frame (51) and is selected to be such that at least one central component (4) can be accommodated in the intermediate space. In addition, a component guide (13), e.g., a stop (15) located at a lower end of the column for the lower, free end of the components (4) mounted in the suspended state, may be present at the support means (9).

The likewise obliquely directed carrier (8) is held at its lower, release-side carrier end (12) by the two gripping means (18, 19) and it passes through the opening (3) of the safety means (2) with the majority of its length and with the upper, loading-side carrier end (11). In addition, the separating device (10), which comprises, similarly to the aforementioned retainer (69), a controllable separating finger (27), which fixes the particular frontmost component (4) in the stack (5) in front of the upper gripping means (18), is arranged at the support means (9). The separating finger acts, e.g., on the upper edge of the component and can be raised and lowered by means of a remote control and a corresponding setting means.

FIG. 6 shows the beginning of separation, when both gripping means (18, 19) and the separating device (10) are closed. In the next step in FIG. 7, the upper gripping means (18) opens, and the separating device (10) simultaneously or subsequently releases a component (4) and blocks the next one. The individual component (4) slides downwards on the carrier (8) until it strikes the lower gripping means (19) and the stop (15). In the next step according to FIG. 8, the upper gripping means (18) closes again and fixes the carrier (8), and the lower gripping means (19) subsequently opens and lets the component (4) slide further downward on the carrier to the release side (33) and towards a mount that may possibly be present there. FIG. 9 shows again the starting position, in which both gripping means (18, 19) are closed and fix the carrier (8) with one another.

FIGS. 11 through 14 illustrate the situation during the transfer of the stack at the unloading site (48). The conveying means (49) has a docking means (60), with which it can be brought into a correct position for transfer at the feeding means (7). The docking means (60) is arranged, e.g., at the frame (51) in the embodiment being shown. As an alternative, it may be located at the conveying means (50). It has, for example, at least one conical pin, which is inserted into a corresponding mounting opening and ensures positioning in connection with airborne mounting. In the embodiment being shown, the frame (51), which can travel with the running gear (54), is brought by an operator manually into position, and, e.g., the pin element located at the bottom part of the frame (51) is brought into a corresponding mounting opening at the projection, which may be located, e.g., at the feeding means (7) or stationarily in front of the protective fence (2).

Operating materials and control signals can be exchanged via the docking means (60) by means of suitable operating material couplings. The mobile parts of the frame (51), e.g., the loading means (56) or a setting means for raising and lowering, closing, folding or moving the frame (51) or parts of the frame (51) in another way may have motorized drives, which are supplied with energy, e.g., current, via the docking means (60). The frame (51) may have, moreover, an integrated control (not shown), with which the necessary motions of the frame (51) or of the loading means (56) take place automatically after docking and are controlled. This control can receive and exchange suitable signals for position feedback, for performed docking or for other purposes via the docking means (60).

As an alternative or in addition, the docking means (60) provided at the unloading site (48) for positioning and docking the frame (51) and the carrying means (55) may have a plug-type positive-locking connection (61) for the carrier (8) and the carrying means (55). FIG. 15 shows this arrangement in an enlarged view. The positive-locking connection (61) is provided especially as a supporting pin connection, with which the carrying means (55) can supportingly engage at its lower, release-side end (59) the upper free end of the carrier. For example, the carrying means (55) has for this purpose an axially projecting pin, which meshes with a fitting axial mounting opening of the carrier (8). The axial orientation and connection of the carrier and the carrying means (55) is ensured by means of this.

As is illustrated in FIG. 11, the stack (5) of components at the feeding means (7) is almost used up and must be replenished. The frame (51) is maneuvered and docked in the unloading position in a suitable manner. The loading means (56) or the bracket (62) now still grasps the carrying means (55) at both ends. After docking, the lower gripping means (64) and subsequently the retainer (69) are opened according to FIG. 12, so that the stack (5) of components can slide onto the carrier (8) in the direction of release (70) or the loading direction (31). FIG. 13 shows the accomplished transfer. The bracket (62) then closes again and the empty frame (51) can be brought back according to FIG. 14 for the repeated loading.

FIGS. 16 through 18 show the variant mentioned in the introduction, in which the stack (5) of components is replaced together with the carrying means (55) during unloading. The conveying of the frame with a floor-mounted vehicle (50) is also shown here in a simplified exemplary form. As is illustrated in FIG. 16, the carrying means (55) also forms the carrier (8) of the feeding means and is transferred from the frame (51) during unloading to the feeding means (7) into the opened carrying means (7) of the latter. The carrier (8) is held for this purpose by the loading means (56) or the bracket (62) at the frame (51) in such a way and has such an excessive length that it projects forward to the extent that it can be grasped according to FIG. 16 by the gripping means (18, 19) in the docked position. For the necessary feed motion, the frame (51) can be moved and fed by means of a running gear (54) or parts of the frame can be moved and fed by means of suitable setting means symbolized by arrows in any desired and suitable manner. FIG. 16 shows the transfer position, from which the lower gripping means (64) as well as the retainer (69) open after closure of the feed-side gripping means (18, 19) at the frame (51), so that the stack (5) of components can slide off towards the feeding means (7). The upper gripping means (63) may still be closed and hold the carrier (8) during the release of the stack. The stack (5) of components now slides through the opening (3) in the safety means (2).

The upper gripping means (63) also opens after the stack has been transferred, so that the carrier (8) is completely released and the frame (51) with the empty bracket (62) can be returned to the loading site (47), where a new carrier (8) or a carrying means (55) is transferred to the frame (51) and loaded at the same time or subsequently with a stack (5) of components. During the above-described change of the carriers at the feeding means (7), the empty carrier (8) is removed, moreover, in a suitable manner and optionally transferred to the frame (51) and an intermediate bracket present there and is returned.

In another embodiment, not shown, the carrier (8) or the carrying means (55) can alternatively be moved by the frame together with the stack (5) of components via a corresponding oblique feed axis in order to avoid the frontal projection of the carrier at the frame (51), which is necessary in the above-mentioned embodiment. In another variant, the carrier (8) may be designed as a carrier capable of performing telescopic motions.

FIGS. 16 through 18 show a variant of the docking means (60), in which the conveying means (50) positioned in a suitable manner by means of another docking means (not shown) is brought into an unloading position, from which the frame (51) is unloaded and brought into the operating and carrier transfer position by means of the docking means (60). Docking of the conveying means (50) may be sufficient, as an alternative, in case of a correspondingly accurate loading means (73) of the conveying means (50) to guarantee sufficiently accurate positioning of the feeding means (7).

As is illustrated in FIG. 5, the individual components (4) may have a code (72), which contains the production-relevant data and an identification of the components (4). As an alternative or in addition, the stack (5) of components can be coded. For example, a rewritable code (72), which contains at least the identification and the sequence of the components (4), may be present for this at the frame (51). The production-relevant data of the components can be stored on the code (72) on the frame (51). The code (72) may be of any desired and suitable design, e.g., it may be a passive or active transponder, a bar code mark or the like.

Reading means (not shown), with which the codes (72) are read, are located in the logistics system (42) at one or more sites. Writing means are likewise present at suitable sites. The reading and writing means are connected to a higher-level control (not shown), which reads and stores the read values and the corresponding position data. The flow of materials can be monitored and controlled by means of this. The components (4) or the stack (5) of components can also be assigned to the conveying means (50) by means of the codes (72). It can be checked at the unloading site (48) whether the correct stack (5) of components containing the correct components (4) is delivered. The data exchange may take place, e.g., via the docking means (60).

Various variants of the embodiments shown and described are possible. This applies to the design embodiment of the conveying means (49) and its components. Instead of the rigid frame (51), a mobile construction may be used, which can be folded up or otherwise reduced in size for the return to reduce the volume to be conveyed. Furthermore, the loading means (56) may have different kinematics, e.g., by picking up and stacking the components (4) at first in the horizontal position as well as conveying the stack (5) of components in the horizontal position and standing up the carrying means (55), aligning it with the feeding means (7) and docking it only at the unloading site (48). In the embodiment shown and described, the carrying means (55) and the carrier (8) are loaded and unloaded on different sides. In a variant of this, the loading and unloading may take place on the same side. Furthermore, the stack (5) of components with the carrying means (55) can be transferred to the feeding means (7) in the manner mentioned in the introduction, the feeding means having a corresponding additional holder, which holds the docked carrying means (55) at the rear free end. In another variant, the brackets and gripping means shown may be present as multiple brackets and gripping means in order to make possible wider spans and mount lengths of the carrier (8) and the carrying means (55).

While specific embodiments of the invention have been shown and described in detail to illustrate the application of the principles of the invention, it will be understood that the invention may be embodied otherwise without departing from such principles.

1-32. (canceled)

33. A conveying device for conveying mechanical components, body part components or other vehicle part components, the conveying device comprising:
a portable frame for receiving at least one said stack of components;
a bar-shaped carrying means associated with said frame for receiving said components in said stack; and
a loading means for attaching individual components to said carrying means at a loading site and to release said stack of components at an unloading site.

34. A conveying device in accordance with claim 33, wherein said loading means includes release means for one of pushing off a stack of components from said carrying means and for releasing said stack of components together with said carrying means.

35. A conveying device in accordance with claim 33, wherein said loading means has a mobile bracket for holding said carrying means detachably and at least at times airborne.

36. A conveying device in accordance with claim 35, wherein said movable bracket holds said carrying means horizontally or obliquely for receiving said components in an upright and/or suspended position.

37. A conveying device in accordance with claim 36, further comprising a feeding means wherein an oblique position of said carrying means is adapted to an oblique position of a carrier at said feeding means.

38. A conveying device in accordance with claim 35, wherein said movable bracket has at least two gripping means, which are spaced part and can be actuated one by one, for detachably holding said carrying means, said gripping means being adapted to hold said carrying means at ends thereof, said gripping means having one or more supporting arms with end-side gripping elements.

39. A conveying device in accordance with claim 33, wherein said loading means has gripping means for detachably holding said carrying means wherein said gripping means has two supporting arms pivotable about a drag bearing.

40. A conveying device in accordance with claim 33, wherein said gripping means includes shell-shaped gripping elements.

41. A conveying device in accordance with claim 33, wherein said loading means includes a controllable retainer for said stack of components.

42. A conveying device in accordance with claim 33, wherein said frame has at least one essentially vertical support and at least one laterally projecting arm.

43. A conveying device in accordance with claim 33, wherein said frame has one of running gear and running gear with a drive therefor.

44. A conveying device in accordance with claim 33, wherein said conveying means includes a vehicle for conveying one or more said frame.

45. A conveying device in accordance with claim 33, wherein said conveying means has a docking means for positioning and docking at said unloading site, said docking means including a plug-type positive-locking connection.

46. A conveying device in accordance with claim 45, wherein said plug-type positive-locking connection comprises a supporting pin connection and said carrier at said feeding means includes a carrier and said plug-type positive-locking connection is provided between said carrying means and said carrier.

47. A conveying device in accordance with claim 33, wherein said frame and said loading means are manually operatable.

48. A logistics system for mechanical components, body part components or other vehicle part components, the logistics system comprising:
a prefabrication unit;
a machining station with a feeding means, said prefabrication unit being arranged at a spaced location from said machining station being arranged separated in space; and
a conveying means for receiving the components piece by piece at said prefabrication unit while forming at least one stack of components on said conveying means and for conveying said stack of components to said machining station and for releasing said stack of components to said feeding means at said machining station.

49. A logistics system in accordance with claim 48, wherein said conveying means comprises:
a portable frame for receiving at least one said stack components;
a bar-shaped carrying means associated with said frame for receiving said components in said stack; and
a loading means for attaching individual components to said carrying means at a loading site and to release said stack of components at an unloading site.

50. A logistics system in accordance with claim 49, wherein said prefabrication unit comprises a press for sheet metal parts.

51. A logistics system in accordance with claim 49, wherein said machining station comprises a joining station.

52. A logistics system in accordance with claim 49, wherein said feeding means of said machining station has a separating device with at least one carrier, to which said stack of components can be attached.

53. A logistics system in accordance with claim 49, wherein said machining station has a surrounding safety means including a protective fence, wherein said feeding means is arranged in or at an opening of said safety means and said carrier extends to an outside through said opening.

54. A logistics system in accordance with claim 49, wherein said feeding means has at least one said support means with a plurality of gripping means located mutually at spaced locations from one another and controllable individually for alternatingly holding and releasing said carrier.

55. A logistics system in accordance with claim 49, wherein said components have:
at least one passage opening closed on the circumferential side; and
a code.

56. A process for conveying mechanical components, body part components or other vehicle part components, the process comprising:
picking up components one by one on a bar-like carrying means of a portable frame by means of a loading means at a loading site;
conveying a stack of components on the portable frame to an unloading site;
releasing the components in a stack at the unloading site using the loading means.

57. A process in accordance with claim 56, wherein:
said stack of components is one of pushed off from said carrying means by means of the loading means and released by said loading means together with said carrying means; and
said carrying means is held detachably and at least at times airborne by means of a movable bracket of said loading means.
